(19) United States
(12) Patent Application Publication
(10) Pub. No.: US 2024/0261887 A1
(43) Pub. Date: Aug. 8, 2024

(54) DISSIMILAR METAL JOINT AND ELECTRIC RESISTANCE WELDING METHOD FOR PREPARING THE SAME

(71) Applicant: Shanghai Institute of Optics And Fine Mechanics, Chinese Academy of Sciences, Shanghai (CN)

(72) Inventors: Mingfeng LI, Shanghai (CN); Shanglu YANG, Shanghai (CN); Wu TAO, Shanghai (CN); Yanjun WANG, Shanghai (CN)

(21) Appl. No.: 18/641,316

(22) Filed: Apr. 19, 2024

Related U.S. Application Data
(63) Continuation of application No. PCT/CN2022/113073, filed on Aug. 17, 2022.

(30) Foreign Application Priority Data
Oct. 21, 2021 (CN) 202111229295.6

(51) Int. Cl. B23K 11/11; F16B 5/08

(52) U.S. Cl. CPC B23K 11/115; F16B 5/08

(57) ABSTRACT

An electric resistance welding method for a dissimilar metal joint used for welding a laminated structure, with an outer layer being composed of iron or iron-based alloy, and an inner layer being composed of a metal with a density of less than 5 g/cm³ or a melting point of lower than 800° C. The electric resistance welding method comprises an expulsion stage in which a light metal or low-melting-point metal in the middle of the laminated structure is separated in a splashing mode, so that a connecting structure is directly formed between iron or iron-based alloy layers in a welding interface to complete welding. According to the invention, the formation of brittle intermetallic compounds on the welding interface of the dissimilar joint can be avoided, thereby improving the mechanical properties of the joint and achieving reliable connection between dissimilar metals. The invention further provides a dissimilar metal joint.

### CROSS-REFERENCE TO RELATED APPLICATIONS

The subject application is a continuation of PCT/CN2022/113073 filed on Aug. 17, 2022, which in turn claims priority on Chinese Patent Application No. CN202111229295.6 filed on Oct. 21, 2021 in China. The contents and subject matters of the PCT international stage application and Chinese priority application are incorporated herein by reference.

### TECHNICAL FIELD

The present invention belongs to the field of welding, and more particularly, relates to a dissimilar metal joint and an electric resistance welding method for preparing the dissimilar metal joint.

### BACKGROUND ART

With the continuous improvement of energy conservation and emission reduction requirements, a lightweight design has become an important issue faced by the automotive industry. Design solutions, such as all-aluminum bodies, have already appeared in products of a few luxury brands. However, the all-aluminum bodies are expensive and difficult to maintain, and their prices are always hardly accepted widely by general consumers. Therefore, in mainstream products on the market, the main body of the body structure is still mainly made of steel, especially structural parts such as A-pillars, B-pillars, door reinforcing plates, and longitudinal beams, and high-strength steel and even ultra-high-strength steel are replacing original ordinary steel and gaining more applications. At the same time, automotive companies and consumers are gradually finding that the use of light alloy materials, including aluminum alloys and magnesium alloys, in localized regions such as shock absorbers, wheel cover end panels, floors, engines, and coverings outside bodies, is an acceptable scheme in terms of both cost and performance. Therefore, automobile manufacturing schemes of compounding steel and light metal is getting more and more favor. The importance of a connection process for steel and light metal dissimilar joints is highlighted.

Electric resistance welding is mostly used in the traditional body-in-white manufacturing process to perform electric resistance welding connection on steel plates. However, physical properties of steel, especially of high-strength steel, are greatly different from physical properties of aluminum alloys and magnesium alloys. The steel has a melting point that is generally higher than 1400° C., while the melting points of the aluminum alloys and the magnesium alloys are mostly lower than 700° C. In the traditional electric resistance welding process, a large number of porous cracks and other defects will appear in welded joints made of the steel and the aluminum and magnesium alloys, and a large number of brittle iron-aluminum or iron-magnesium intermetallic compounds will be formed in a welding region, which will seriously affect the mechanical strength of the joints.

A three-layer composite structure of steel workpiece-aluminum workpiece-steel workpiece or steel element-aluminum workpiece-steel workpiece is adopted in part of the prior arts, where the steel elements are common specially designed rivets, including special solid, hollow and semi-hollow rivets, etc. When these combinations are welded, the welding region is first heated, or the steel element is driven and kept in a high-speed rotation state to contact and extrude the aluminum workpiece so that an aluminum plate in the middle is softened or reaches a semi-molten state at a high temperature, and then a scheme is used such that the softened or semi-molten aluminum alloy is extruded out of the welding region by means of high pressure provided by welding equipment, and thus, welded directly between an outermost steel plate or steel element and the steel workpiece. However, the inventors have recognized that the heated high-temperature aluminum alloy will be in contact with the steel plate for a longer period of time during this process, resulting in the formation of a large number of brittle intermetallic compounds, and that the aluminum alloy in a high-temperature plastic state will also be hardly discharged out of the welding region effectively, thereby affecting the welding quality. When aluminum and steel dissimilar metals are welded, a solid solubility of iron in aluminum is relatively high, and aluminum is almost insoluble in iron, so a large number of solid solutions cannot be formed between iron and aluminum, and a large number of iron-aluminum brittle intermetallic compounds (such as FeAl₃, Fe₂Al₅, FeAl₂, FeAl and Fe₃Al) are quickly formed in a weld seam during welding. These brittle intermetallic compounds are usually distributed in a laminar structure on a welding interface and are highly susceptible to sprouting cracks and providing crack extension while bearing external stressed compound layers, resulting in a significant adverse effect on the strength of a final joint.

### SUMMARY OF THE INVENTION

An object of the present invention is to provide an electric resistance welding method for a dissimilar metal joint, which solves the problems of low welding strength, the presence of a large number of brittle intermetallic compounds at a welding interface, and the tendency to sprout cracks when welding dissimilar metals by electric resistance spot welding.

Another object of the present invention is to provide a dissimilar metal joint which has a reliable connection.

The present invention provides an electric resistance welding method for a dissimilar metal joint. The electric resistance welding method of the present invention is used for welding a laminated structure of dissimilar metals, wherein the laminated structure comprises first-class metal plates and a second-class metal plate; the first-class metal plates are made of pure iron or iron-based alloy; and the second-class metal plate is made of an elementary substance or an alloy with a density of less than 5 g/cm³ or a melting point of lower than 800° C. Plates on the outer sides of the laminated structure are the first-class metal plates, and the second-class metal plate is located between the first-class metal plates. The electric resistance welding method of the present invention comprises a step of discharging the second-class metal plate from a welding region and a welding stage, wherein the step of discharging the second-class metal plate further comprises an expulsion stage. In the expulsion stage, a expulsion current and an electrode pressure are applied to the laminated structure, so that the laminated structure in the welding region is heated; a second-class metal is molten and separated from the welding region in a splashing mode under pressure; and first-class metals approach each other by means of resistance heat and pressure, wherein the second-class metal plate flies away completely from at least part of the welding region. In the welding stage, a welding interface consisting only of the first-class metal plates which are in contact with each other is formed in the at least part of the welding region, and the welding interface produces a metallurgical connection.

Optionally, the expulsion current comprises one or more current pulses, preferably 2-5 current pulses, and a duration of a single current pulse does not exceed 200 ms, preferably 50 ms-120 ms.

Further, the expulsion current has an intensity I1=K1*I0, wherein I0 is a current intensity when the first-class metal plates in the dissimilar metal joint are separately subjected to electric resistance welding to form a nugget having a section diameter of greater than or equal to 4\sqrt{t}, t is a thickness of the thinner plate in the first-class metal plates, and K1 has a value range of 0.8-3.5.

Optionally, in the expulsion stage, a welding interface which consists only of the first-class metal plates which are in contact with each other is formed after the second-class metal plate is separated from the welding region in a splashing mode, a second-class metal layer remaining in the welding interface has a thickness of less than or equal to 0.15 mm, and an equivalent diameter of the welding interface is greater than or equal to 0.5 times a diameter of the electrode end surface; and preferably, the remaining second-class metal layer has a thickness of less than or equal to 0.05 mm.

Preferably, in the welding stage, a welding current and an electrode pressure are applied to the laminated structure, and the welding current has an intensity of less than or equal to the intensity of the expulsion current.

Further, the welding current has an intensity I2=K2*I0, wherein I0 is a current intensity when the first-class metal plates in the dissimilar metal joint are separately subjected to electric resistance welding to form a nugget having a section diameter of greater than or equal to 4\sqrt{t}, t is a thickness of the thinner plate in the first-class metal plates, and zK2 has a value range of 0.5-2.5. The intensity of the welding current can be controlled to ensure the welding strength of a dissimilar joint obtained by the electric resistance welding method.

Optionally, an interval between the expulsion current and the welding current is 0 ms-200 ms.

Optionally, the method further comprises a tempering stage after the welding stage; and in the tempering stage, an electrode provides a tempering current for the welding region. The tempering process can improve the mechanical properties of the joint.

Further, the tempering current has an intensity I3=K3*I0, wherein I0 is a current intensity when the first-class metal plates in the dissimilar metal joint are separately subjected to electric resistance welding to form a nugget having a section diameter of greater than or equal to 4\sqrt{t}, t is a thickness of the thinner plate in the first-class metal plates, and K3 has a value range of 0.4-1.8.

Optionally, the method further comprises a preheating stage prior to the expulsion stage; and in the preheating stage, the electrode provides a preheating current for a region to be welded. The preheating process allows an aluminum or magnesium alloy in an interlayer to melt more quickly, facilitating the occurrence of the splashing process.

Further, the preheating current has an intensity I4=K4*I0, wherein I0 is a current intensity when the first-class metal plates in the dissimilar metal joint are separately subjected to electric resistance welding to form a nugget having a section diameter of greater than or equal to 4\sqrt{t}, t is a thickness of the thinner plate in the first-class metal plates, and K4 has a value range of 0.2-1.3.

Optionally, the welding method further comprises a preheating stage prior to the expulsion stage, and in the preheating stage, the electrode provides a preheating current for the region to be welded; and further comprises a tempering stage after the welding stage, and in the tempering stage, the electrode provides a tempering current for the welding region; the expulsion current has an intensity I1=K1*I0, the welding current has an intensity I2=K2*I0, the preheating current has an intensity I4=K4*I0, and the tempering current has an intensity I3=K3*I0, wherein K1 has a value range of 0.8-3.5, K2 has a value range of 0.5-2.5, K4 has a value range of 0.2-1.3, and K3 has a value range of 0.4-1.8, K₁≥K₂≥K₃≥K₄.

Further, the welding current, the preheating current, and the tempering current each have at least one current pulse, and an action time does not exceed 800 ms, preferably 200-700 ms. Further, an interval of 0-200 ms, preferably 5-80 ms, exists between the welding current or the preheating current and the expulsion current, and between the tempering current and the welding current.

Optionally, a coating exists on the surface of at least one of the first-class metal plates, and the coating is a zinc-based coating or an aluminum-based coating.

Optionally, a structural form of the laminated structure is a three-layer group or a five-layer group; two outer layer groups of the three-layer group are single layers or adjacent superimposed layers of the first-class metal plates, and an inner layer group is a single layer or adjacent superimposed layers of the second-class metal plates; two outer layer groups and an intermediate layer group of the five-layer group are single layers or adjacent superimposed layers of the first-class metal plates, and the other two layer groups are single layers or adjacent superimposed layers of the second-class metal plates, and are respectively located between the outer layer groups and the intermediate layer group; and in the welding stage, the adjacent first-class metal plates are in direct contact with each other and welded under an electrode pressure.

Further, at least two layers of the first-class metal plates in the laminated structure are formed by bending the same metal plate, and the bent position is located outside the welding region.

Optionally, the second-class metal plate is made of any one or any laminated combination of at least two of aluminum, an aluminum alloy, magnesium and a magnesium alloy.

Optionally, the first-class metal plate has a tensile strength of not more than 2500 MPa, a micro Vickers hardness of not more than 650 Hv, and a single-layer thickness in a range of 0.5 mm-2.5 mm.

Optionally, a thickness of a single layer or adjacent superimposed layers of the second-class metal plates between the first-class metal plates which are spaced adjacently is less than or equal to 4.5 mm, and a total thickness of a single layer or adjacent superimposed layers of the first-class metal plates is less than or equal to 5.5 mm.

Optionally, the single layer or adjacent superimposed layers of the first-class metal plates satisfy a condition: a product A of the thickness (in mm) of the plate and the tensile strength (in MPa) satisfies 100≤A≤5000.

Optionally, one of the plates on both outer sides of the laminated structure has a smaller value of the product of the thickness (in mm) and the tensile strength (in MPa) of the plate compared to the other.

The present invention further provides a dissimilar metal joint. The dissimilar metal joint is of a laminated structure, where the laminated structure comprises first-class metal plates and a second-class metal plate; the first-class metal plates are made of pure iron or iron-based alloy; the second-class metal plate is made of an elementary substance or an alloy with a density of less than 5.0 g/cm³ or a melting point of lower than 800° C.; plates on the outer sides of the laminated structure are the first-class metal plates, and the second-class metal plate is located between the first-class metal plates. From the perspective of an appearance of the dissimilar metal joint, a thickness of the dissimilar metal joint in an indentation region on the electrode end surface is less than or equal to a sum of the thicknesses of the first-class metal plates, the thickness of the joint structure gradually increases from an edge of the indentation region on the electrode end surface to the outside, and finally an originally combined laminated structure is presented; and from the perspective of a cross section of the dissimilar metal joint, the indentation region on the electrode end surface and its surrounding materials present the characteristics of being thin in the middle and thick in both sides, a middle indentation region in the indentation regions on the electrode end surface consists only of the first-class metal plates, and interatomic bonding occurs between the first-class metal plates at an interface to form a permanent connection; and the thickness of the laminated structure gradually increases from the edge of the indentation region to the outside, and the second-class metal plate gradually increases from a smaller thickness between the first-class metal plates to an original thickness of the second-class metal plate.

Optionally, a “jet-like” solidification structure formed by melting and splashing of the second-class metal plate exists between the first-class metal plates outside the indentation region.

Optionally, an intermetallic compound (IMC layer) is produced at a contact interface between the second-class metal plate and the first-class metal plate in the indentation edge region on the electrode end surface.

Further, among the first-class metal plates in the laminated structure, at least two layers are formed by bending the same metal plate, and the bent position is located outside the welding region.

The present invention further provides a dissimilar metal joint which is obtained by the electric resistance welding method of the present invention.

The present invention has the following advantages.

First, by means of a splashing characteristic in the method of the present invention, light metals can be effectively discharged from the laminated structure in order to avoid adverse effects of the light metals on the joint connection. In the common perception in the art, splashing during electric resistance spot welding is a defect to be avoided, but the splashing phenomenon is exploited in the present invention. By applying the expulsion current to the welding region, the second-class metal located in the intermediate layer is rapidly molten, and the molten liquid metal instantly breaks through a plastic deformation region around a liquid-state region and is separated from the welding region in a splashing mode under the combined action of electrode pressure and current heating, such that there is only a trace amount or even no second-class metal in the welding region to achieve a close contact between the first-class metal plates, thereby avoiding the generation of a large number of brittle intermetallic compounds (IMC layer) in the welding interface in the subsequent welding stage, and effectively improving the welding quality. The method of the present invention is simple, high in efficiency, wide in application scope, and high in connection quality.

Second, the expulsion stage in the present invention can be implemented by a plurality of pulses, which can take an effect of discharging the light metals by multiple heating and realize the discharge of the light metals from the laminated structure to the maximum extent, thus satisfying the connection of the laminated structure including a plurality of layers of light metals.

Third, the method of the present invention can achieve a high-quality connection between the light metals and the laminated structure in which a plurality of steel plates are spaced, independent of types, components and processing methods of the light metals and the strength of the steel plates, and can, for example, achieve the connection in the cases of magnesium alloys, aluminum cold-rolled plates, aluminum alloy profiles, cast aluminum, and the presence of ultra-high-strength hot-formed steel in the middle.

Fourth, compared with existing methods for direct electric resistance spot welding of steel and aluminum, the method of the present invention avoids direct contact between the electrode and the light metals, which can greatly prolong the service life of the electrode and improve the connection quality of the joint.

Fifth, the method of the present invention has an extremely broad application market compared to similar existing technologies, as it does not require the specialized preparation of steel metal elements with locking characteristics and does not require the piercing of light metals or steel workpieces.

### BRIEF DESCRIPTION OF THE DRAWINGS

FIG. 1 shows the laminated structure in one embodiment of the dissimilar metal joint of the present invention.

FIG. 2a shows the laminated structure according to another embodiment of the dissimilar metal joint of the present invention; and FIG. 2b shows the laminated structure in yet another embodiment of the dissimilar metal joint in the present invention.

FIG. 3 shows the laminated structure in yet another embodiment of the dissimilar metal joint in the present invention.

FIG. 4 shows the relationship of the current, electrode pressure, and time in an embodiment of the electric resistance welding method for a dissimilar metal joint in the present invention. The vertical axis represents electrode pressure (N) in dotted line (---), and electric current (kA) in solid line (-); and the horizontal axis represents time (ms).

FIGS. 5a, 5b, 5c, 5d and 5e show changes of the welded joint in different welding stages in an embodiment of the electric resistance welding method for the dissimilar metal joint in the present invention.

FIG. 6 shows the welded joint according to an example of the dissimilar metal joint;

FIG. 7 shows the welded joint according to another embodiment of the dissimilar metal joint in the present invention.

FIGS. 8a and 8b show structures of the welded joints according to two other different embodiments of the dissimilar metal joint in the present invention.

FIG. 9 shows the spalling fracture of the welded joint according to Example 1 of the electric resistance welding method for a dissimilar metal joint in the present invention.

FIG. 10 is a cross-sectional metallographical diagram of a welded joint according to Example 2 of the electric resistance welding method for the dissimilar metal joint in the present invention.

FIG. 11 shows the tensile shear load-displacement curve of the welded joint according to Example 2 of the electric resistance welding method for the dissimilar metal joint in the present invention. The vertical axis represents the tensile shear load (N); and the horizontal axis shows the displacement (mm).

FIG. 12 is a cross-sectional metallographic diagram of a welded joint according to Example 4 of an electric resistance welding method for a dissimilar metal joint in the present invention.

FIG. 13 shows the tensile shear load-displacement curve of the welded joint according to Example 4 of the electric resistance welding method for the dissimilar metal joint. The vertical axis represents the tensile shear load (N); and the horizontal axis shows the displacement (mm).

FIG. 14 is a cross-sectional metallographical diagram of a welded joint according to Example 5 of the electric resistance welding method for the dissimilar metal joint in the present invention.

FIG. 15 shows the tensile shear load-displacement curve of the welded joint according to Example 5 of the electric resistance welding method for the dissimilar metal joint in the present invention. The vertical axis represents the tensile shear load (N); and the horizontal axis shows the displacement (mm).

FIG. 16 is a cross-sectional metallographical diagram of a welded joint according to Example 7 of the electric resistance welding method for the dissimilar metal joint in the present invention.

FIG. 17 shows the tensile shear load-displacement curve of the welded joint according to Example 7 of the electric resistance welding method for the dissimilar metal joint in the present invention. The vertical axis represents the tensile shear load (N); and the horizontal axis shows the displacement (mm).

FIG. 18 is a cross-sectional metallographical diagram of a welded joint according to Example 8 of the electric resistance welding method for the dissimilar metal joint in the present invention.

FIG. 19 shows the tensile shear load-displacement curve of the welded joint according to Example 8 of the electric resistance welding method for the dissimilar metal joint. The vertical axis represents the tensile shear load (N); and the horizontal axis shows the displacement (mm).

FIG. 20 is a cross-sectional metallographical diagram of a welded joint according to Example 9 of the electric resistance welding method for the dissimilar metal joint in the present invention.

FIG. 21 is a cross-sectional metallographical diagram of a welded joint according to Example 10 of the electric resistance welding method for the dissimilar metal joint in the present invention.

FIG. 22 is a cross-sectional metallographical diagram of a welded joint according to Example 11 of the electric resistance welding method for the dissimilar metal joint in the present invention.

FIG. 23 is a cross-sectional metallographical diagram of a welded joint according to Example 12 of the electric resistance welding method for the dissimilar metal joint in the present invention.

FIG. 24 is a cross-sectional metallographical diagram of a welded joint according to a comparative example of an electric resistance welding method for a dissimilar metal joint in the present invention.

FIG. 25 shows the tensile shear load-displacement curve of the welded joint according to the comparative example of the electric resistance welding method for the dissimilar metal joint in the present invention. The vertical axis represents the tensile shear load (N); and the horizontal axis shows the displacement (mm).

FIG. 26 is a schematic diagram of various region ranges of the dissimilar metal joint in the present invention.

The purpose of the above accompanying drawings is to describe the technical conception of the invention for the understanding of those skilled in the art, and the accompanying drawings comprise only the parts related to the technical features of the invention, and do not show the invention in its entirety and in all its details.

### DETAILED DESCRIPTION OF THE INVENTION

The present invention is further described in detail through the following specific examples in connection with the accompanying drawings.

The present invention is further set forth below in conjunction with specific examples. It should be understood that the following examples are only used to illustrate the invention, but not to limit the scope of the invention. In addition, the accompanying drawings are schematic. Therefore, the relevant dimensions involved in the methods and joints of the invention are not limited by the dimensions or proportions of the schematic diagrams. It should be noted that, as used in the claims and description of this patent, relation terms such as “first” and “second” are used merely to distinguish a subject or an operation from another subject or another operation, and not to require or imply any substantial relation or sequence between these subjects or operations. Moreover, terms “comprise”, “contain” or any variation thereof are intended to cover a nonexclusive containing, such that a process, a method, an item or a device containing a series of elements not only comprises these elements, but also comprises other elements that are not set forth specifically, or also comprises an inherent element of such a process, method, item or device. The terms “upper,” “lower,” “outer side,” “inner side,” etc., are merely relative descriptions of relative positional relationships and have no specific internal or external limitations. Without further limitation, an element defined by the phrase “comprise a” does not mean that other same elements are excluded from the process, method, item or device including the element.

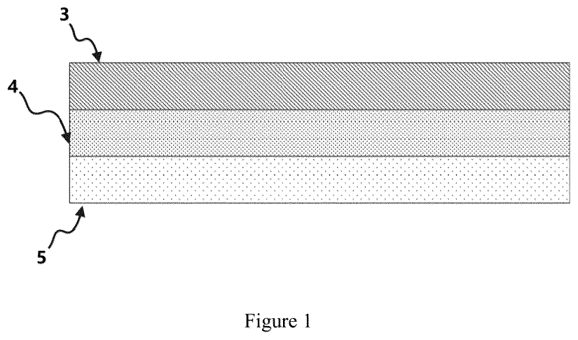

In the present invention, a dissimilar metal joint has a laminated structure as shown in FIG. 1. The laminated structure comprises first-class metal plates 3, 5 and a second-class metal plate 4. The first-class metal plates 3, 5 may be referred to as an upper plate 3 and a lower plate 5 respectively, and the second-class metal plate 4 may become an inner plate 4. The upper plate 3 is made of a first-class metal, the inner plate 4 is made of a second-class metal, and the lower plate 5 is made of the first-class metal. For the upper plate 3 and the lower plate 5, the first-class metal made into the plate is pure iron or iron-based alloy. The specific plate materials may be selected from a plurality of perspectives. For example, in terms of mechanical properties, the plate has a tensile strength of not more than 2500 MPa, and a micro-Vickers hardness of not more than 650 Hv; and for another example, in terms of dimensions, the plate has a single layer thickness in the range of 0.5 mm-2.5 mm, or a product value A of the plate thickness (in mm) and the tensile strength (in MPa) is comprehensively considered to be between 100 and 5000, and the A values of the upper plate 3 and the lower plate 5 in a preferred example are not equal. Any surface of any of the first-class metal plates may be a bare plate or have an aluminum or zinc-based coating such as a zinc coating, an aluminum-silicon coating, a zinc-aluminum coating, or a zinc-nickel coating, or may have a lead-tin coating. For the inner plate 4, the second-class metal made into the plate is an elementary substance or alloy with a density of less than 5 g/cm³ or a melting point of lower than 800° C. The specific plate materials may be selected from a plurality of perspectives. For example, any one of any laminated combination of at least two of aluminum, an aluminum alloy, magnesium and a magnesium alloy may be selected in terms of components, and the thickness should not exceed 4 mm in terms of dimensions.

The upper plate 3, the inner plate 4, and the lower plate 5 are of single-layer plate structures. In other examples, they may also be of a composite structure in which a plurality of layers of plates are superimposed adjacently. The composite structure in which the plurality of layers of plates are superimposed adjacently may be composed of different plate materials that accord with the above constraints, respectively. Regardless of the form of the laminated structure, a total thickness of the first-class metal plates is preferably not more than 5 mm, and a total thickness of the second-class metal plate is preferably not more than 4 mm, in order to facilitate improving the welding quality.

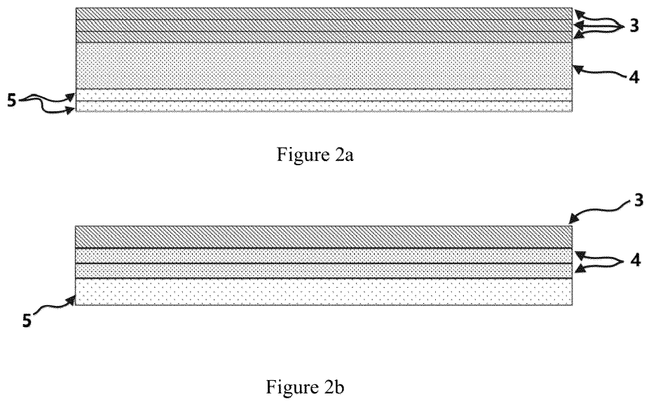

The upper plate 3, the inner plate 4, and the lower plate 5 of the dissimilar metal joint may be set into a multilayer structure, respectively. In the dissimilar metal joint (before welding) shown in FIG. 2a, the upper plate 3 is of a three-layer structure, and the lower plate 5 is a two-layer joint. In the dissimilar metal joint (before welding) shown in FIG. 2b, the inner plate 4 is of a two-layer structure. The multi-layer structures of the upper plate 3, the inner plate 4, and the lower plate 5 may be made of the same material, or a combination of a plurality of different materials satisfying the parameter constraints in the previous examples. For example, the multi-layer structures of the upper plate 3 and the lower plate 5 may be any laminated combination of low-carbon steel and pure iron, and the multi-layer structure of the inner plate 4 may be any one or any laminated combination of at least two of aluminum, an aluminum alloy, magnesium and a magnesium alloy.

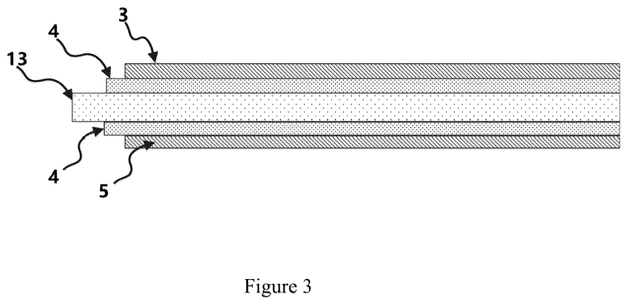

As shown in FIG. 3, another form of the dissimilar metal joint may also be a five-layer group composite structure composed of the upper plate 3 and the lower plate 5 composed of a first-class metal, the inner plate 4 composed of a second-class metal and the inner plate 13 composed of the first-class metal, where each plate layer may be either a single plate or a composite structure in which a plurality of layers of plate materials is superimposed adjacently. For such structures, in the welding stage, the first-class metal plates which are spaced adjacently, namely the upper plate 3 and the inner plate 13, as well as the inner plate 13 and the lower plate 5, are in contact and welded, respectively.

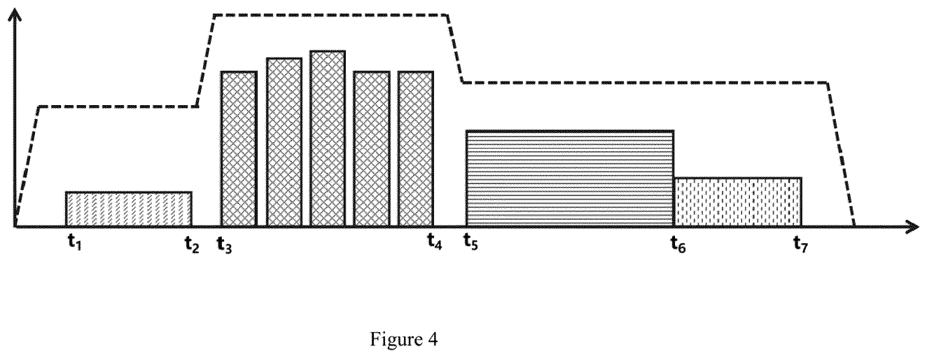

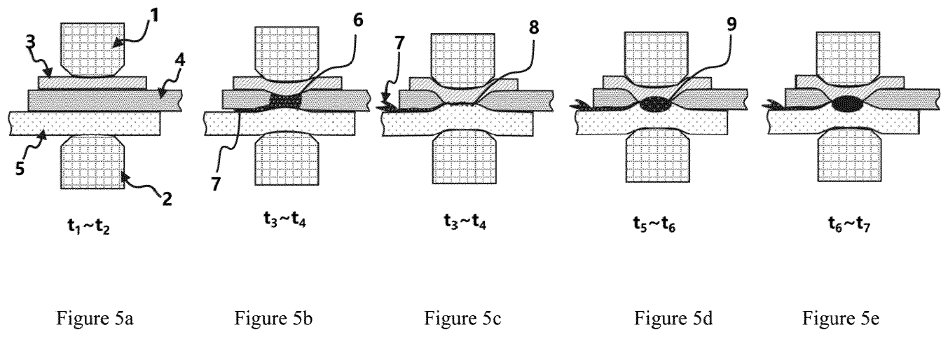

Taking the three-layer laminated structure provided in FIG. 1 as an example, a welding process in an embodiment of the electric resistance welding method for the dissimilar metal joint is described below. In conjunction with FIGS. 5a to 5e, an upper electrode 1 and a lower electrode 2 apply a current and an electrode pressure to the laminated structure during electric resistance welding. In FIGS. 5a to 5e, a horizontal axis is time (ms) and a vertical axis is either an electrode pressure (N) or a current (kA), wherein a dashed line shows the changes in pressure over time, and a solid line shows the changes in current over time. The electric resistance welding process comprises preheating stages of t1-t2, expulsion stages of t3-t4, welding stages of t5-t6 and tempering stages of t6-t7. In each stage, the upper electrode 1 and the lower electrode 2 apply a corresponding preheating current I4, expulsion current I1, welding current I2 and tempering current I3 to the laminated structure, respectively. The electrode pressure changes in stages over time in FIG. 4. In the expulsion stage, a expulsion current and an electrode pressure are applied to the laminated structure, so that the laminated structure in the welding region is heated; the second-class metal is molten and separated from the welding region in a splashing mode under pressure; and the first-class metals approach each other by means of resistance heat and pressure, wherein the second-class metal plate flies away completely from at least part of the welding region. In the welding stage, a welding interface consisting only of the first-class metal plates which are in contact with each other is formed in the at least part of the welding region, and the welding interface produces a metallurgical connection. In another embodiment, the electrode pressure shown in Table 1 may be kept constant throughout the welding process.

The expulsion current and the electrode pressure are applied through a welding electrode, which has an electrode end surface. The complete fly-away of the second-class metal plate during the splashing process comprises the following situation, that is, a trace amount of the second-class metal remains at the welding interface formed by the first-class metal plates which are in contact with each other, and the trace amount of the remaining second-class metal is mixed with a surface coating or matrix elements of the first-class metal, resulting in only a laminated structure composed of the first-class metal being visible when a cross section of a welding spot is observed with naked eyes; and in the subsequent welding process, a trace amount of the remaining second-class metal will be completely fused into a nugget formed by the first-class metal and will have no effect on the welding quality. That is, the trace amount of the remaining second-class metal neither forms a brittle intermetallic compound with the first-class metal, nor affects the properties of the nugget.

Metallurgical connections occur when the first-class metal is mixed with the second-class metal element at the welding interface and when an original contact surface fuses and disappears as a result of the first-class metal connection alone. The metallurgical connections comprise a diffusion connection and a nugget connection in the subsequent examples.

Firstly, a reference current intensity I0 is defined, wherein I0 is a current intensity when the upper plate 3 and the lower plate 5 are separately subjected to single pulse electric resistance welding to form a nugget having a section diameter of greater than or equal to 4\sqrt{t}, and t is a thickness of the thinner plate.

Before the electrode applies a current to the laminated structure, an optional pre-pressing step is applied, which brings the laminated workpieces into close contact and reduces the electric resistance between the plates. As shown in FIGS. 5a to 5e, the pre-pressing pressure may be lower than an electrode pressure in the subsequent splashing and welding stages.

In the preheating stage, as shown in FIG. 5a, the electrode applies a preheating current to the laminated structure, which brings the laminated workpieces closer contact and reduces the electric resistance between the plates. The preheating current has at least one current pulse, and an action time does not exceed 800 ms, preferably 200-700 ms. The preheating current preferentially does not produce splashing. The preheating current has an intensity I4 which numerically satisfies 14=K4*I0. K4 has a value range of 0.2-1.3. In some examples, welding of the laminated structure can still be done in the case of omitting the preheating stage.

In the expulsion stage, as shown in FIG. 5b and FIG. 5c, the electrode applies an expulsion current to the laminated structure. Under the action of the expulsion current, the material of the inner plate 4 within the welding region is molten into a liquid metal 6, and part of the metal forms a splash 7 that is separated from the welding region. A region where no second-class metal exists is formed between the first-class metal plates 3, 5. The first-class metal plates 3, 5 are heated and softened under the action of a current, and approach to the middle under a pressure of the upper electrode 1 and the lower electrode 2, and contact each other in this region where no second-class metal exists to form a welding interface 8. The second-class metal 4 is deformed by extrusion. The thickness of the second-class metal remaining in the welding interface 8 is generally less than or equal to 0.15 mm, and preferably, less than or equal to 0.05 mm. An equivalent diameter of the welding interface 8 is usually not less than 0.5 times a diameter of an end surface of the upper electrode 1 or the lower electrode 2. The expulsion current has an intensity I1 which numerically satisfies 11=K1*I0. K1 has a value range of 0.8-3.5. The expulsion current may be either a single pulse or a plurality of pulses, preferably 2-5 pulses, and a duration of a single pulse does not exceed 200 ms, preferably 50 ms-120 ms.

In the welding stage, as shown in FIG. 5d, the electrode applies a welding current to the laminated structure. The welding current has an intensity that is less than that of the expulsion stage, while the electrode pressure is greater than that of the expulsion stage. The welding current may be either a single pulse or a plurality of pulses, and an action time does not exceed 800 ms, preferably 200-700 ms. The welding current has an intensity I2 which numerically satisfies 12=K2*I0. K2 has a value range of 0.5-2.5. The first-class metal plates 3, 5 are continuously heated under the action of the welding current, and a metal at a contact surface 8 is molten to form a steel nugget 9, until a diameter of the steel nugget 9 reaches 3.5\sqrt{t}, thereby achieving a metallurgical connection between the first-class metal plates 3, 5. A small amount of intermetallic compound (IMC layer) is formed in an interfacial portion of part of the liquid metal of the inner plate 4 remaining around the welding interface in contact with nearby steel. In order to make the upper cover plate 3 fully contact with the lower cover plate 5 after the splashing occurs, an interval of 0-200 ms, preferably 10-70 ms, may be set between the expulsion current and the welding current.

In the tempering stage, as shown in FIG. 5e, the electrode applies a tempering current to the laminated structure to perform heat preservation and tempering treatment on the welding interface, thereby obtaining a uniform weld structure and eliminate residual stress. The tempering current has at least one current pulse, and an action time does not exceed 800 ms, preferably 200-700 ms. The tempering current preferentially does not produce splashing. The tempering current has an intensity I3 which numerically satisfies 13=K3*I0. K3 has a value range of 0.4-1.8. In some examples, welding of the laminated structure can still be done in the case of omitting the tempering stage. The intensity I3 of the tempering current generally does not exceed 15 kA, preferably 4-12 kA.

In the above processes, K1, K2, K3, and K4 should satisfy K₁≥K₂≥K₃≥K₄.

The above-mentioned current is provided by the welding electrode, and has a specific value which may be an effective current or a peak current or an average current, which is easily understood in the art. The welding electrode is used as part of electric resistance welding equipment. The electric resistance spot welding equipment may be widely applied to power frequency welding machines, intermediate frequency welding machines, and AC welding machines in the industry. The electric resistance spot welding equipment may be fixed spot welding equipment or automation equipment driven by a robot, generally including welding tongs of C-type, X-type and other kinds of structural shapes, usually realized by robots or automation components. The welding electrode may be made of any electrically and thermally conductive material, e.g., may be made of copper alloys, including a copper-chromium (CuCr) alloy and a copper-chromium-zirconium (CuCrZr) alloy. Welding surfaces of the copper alloys added with aluminum oxide particles or various other copper alloys that may be used as electrode materials may be spherical surfaces, end planes, and other specially shaped surfaces, such as electrode caps with raised or recessed structural end surfaces on surfaces.

According to specific conditions of different examples, a time interval may be set between the preheating current and the expulsion current, between the expulsion current and the welding current, and between the welding current and the tempering current, respectively. The interval may be set in the range of 0-200 ms, preferably 5-80 ms. During the interval, the welding electrode is maintained in a pressure-holding state.

In other examples, if the upper plate 3 and the lower plate 5 are thicker hot-formed steel, and the inner plate 4 is a very thin aluminum plate, the process of the expulsion stage in the electric resistance welding process is very short, an aluminum material constituting the inner plate 4 may be quickly separated from the welding interface within a short time, and the expulsion current I1 and the welding current I2 may be consistent at this time. The duration required for the welding stage is also relatively short, so that the upper plate 3 and the lower plate 5 made of the hot-formed steel are not molten in the welding region but are fixed together in the form of diffusion welding. In such examples, no nugget is produced in the joint structure.

The above-mentioned electric resistance welding method is not limited to the three-layer laminated structure, but is also suitable for the laminated structure shown in FIG. 2a, FIG. 2b, and FIG. 3, wherein I0 is a current intensity when the first-class metal plates are separately subjected to single pulse electric resistance welding to form a nugget having a section diameter of greater than or equal to 4\sqrt{t}, and t is a thickness of the thinner plate in the first-class metal plates. Taking FIG. 2a as an example, t is the thickness of a thinner plate among three plate layers in the upper plate 3 and two plate layers in the lower plate 5. Taking FIG. 3 as an example, t is the thickness of a thinner plate among the upper plate 3, the inner plate 13 and the lower plate 5.

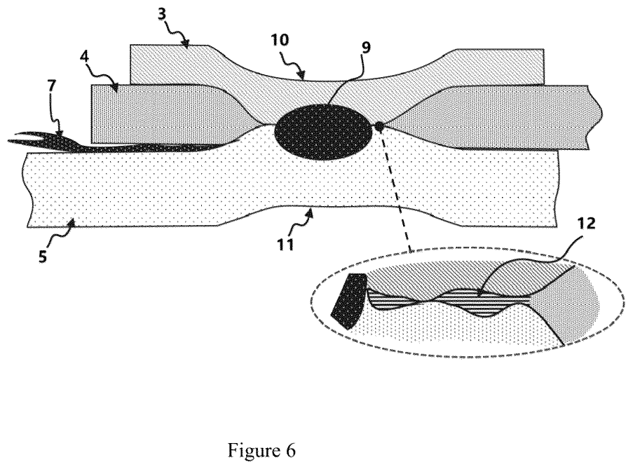

With the above embodiments, it is possible to obtain a dissimilar metal joint provided by another aspect of the embodiments of the present invention. A typical joint structure is as shown in FIG. 6. The dissimilar metal joint is of a laminated structure. The laminated structure comprises first-class metal plates and a second-class metal plate. The first-class metal plates are made of pure iron or iron-based alloy and comprise an upper plate 3 and a lower plate 5. The second-class metal plate is made of an elementary substance or an alloy with a density of less than 5.0 g/cm³ or a melting point of lower than 800° C. and comprises an inner plate 4. From the perspective of appearance, a thickness of the dissimilar metal joint between indentation regions 10, 11 on the electrode end surface is less than or equal to the sum of the thicknesses of the first-class metal plates 3, 5. The thickness of the joint structure gradually increases from the edges of the indentation regions 10, 11 of the electrode end surface to the outside, and finally an originally combined laminated structure is presented. From the perspective of a cross section of the dissimilar metal joint, indentation regions 10 and 11 on the electrode end surface and their surrounding materials present the characteristics of being thin in the middle and thick in both sides. A middle indentation region among the indentation regions on the electrode end surface consists only of the first-class metal plates, and interatomic bonding occurs between the first-class metal plates at an interface to form a permanent connection. This permanent connection may be a solidified nugget 9 or a metallic interface where a solid-state diffusion connection occurs. The thickness of the laminated structure gradually increases from the indentation edge to the outside. The first-class metal plates on the outer sides are V-shaped. The second-class metal plate gradually increases from a smaller thickness to an original thickness of the second-class metal plate between the V-shaped structure formed by the first-class metal plates. The second-class metal plate that is deformed during the splashing process usually conforms to a characteristic in the joint structure that an equivalent diameter of a region within the indentation regions 10 and 11 on the electrode end surface whose thickness is less than or equal to 0.15 mm is not less than 0.5 times a diameter of an end surface of the upper electrode 1 or the lower electrode 2.

In general cases, there exists a jet-like solidification structure formed by the solidification of the splash 7 formed by melting of the second-class metal plate, i.e., the inner plate 4, between the inner plate 4 and the upper plate 3 or the lower plate 5 during the splashing process.

As shown in FIG. 6, in the indentation edge region on the electrode end surface, the surfaces of regions of the inner plate 4 composed of the second-class metal plate which are in contact with the upper plate 3 and the lower plate 5 composed of the first-class metal plates are molten to produce an intermetallic compound (IMC layer) 12. Among the second-class metal plates on the outer sides of the intermetallic compound 12 which are deformed by extrusion, an equivalent diameter of a region (including a nugget) of the second-class metal plate with a thickness of less than or equal to 0.15 mm is generally not less than 0.5 times the diameter of the end face of the upper electrode 1 or the lower electrode 2. In some examples, the IMC layer may also be formed by diffusion between the second-class metal plate and the first-class metal plate.

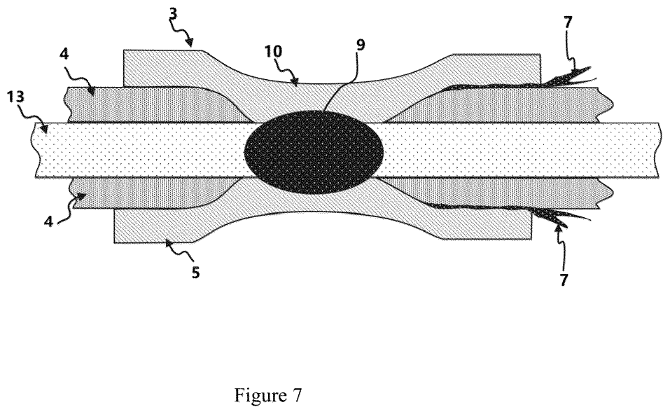

In other examples, the upper plate 3, the inner plate 4 and the lower plate 5 in the dissimilar metal joint may be single-layered or multi-layered, or a three-layer structure as shown in FIG. 6, or a five-layer structure as shown in FIG. 7 in which an interlayer 13 composed of the first-class metal is added between the inner plates 4 composed of a plurality of second-class metal layers.

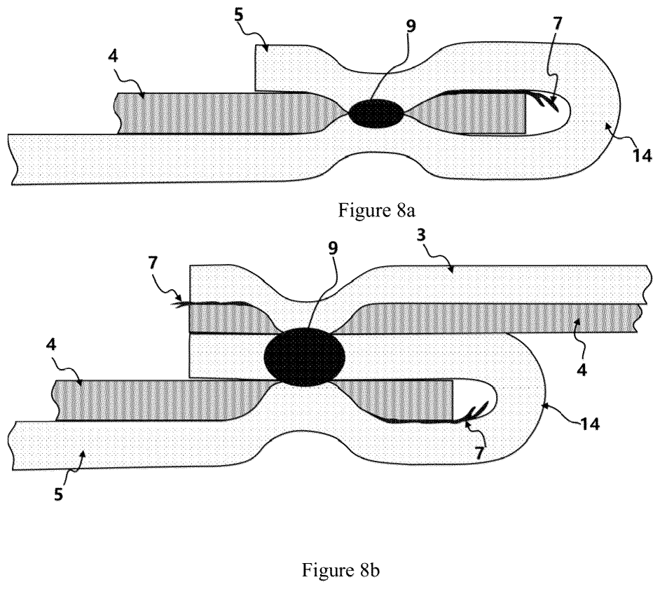

As shown in FIG. 8a and FIG. 8b, another form of the dissimilar metal joint may also lie in that a bent first-class metal plate forms at least two layers in the laminated structure, and a bent portion 14 is located outside the welding region. The laminated structure may be a three-layer structure as shown in FIG. 8a, in which the outer sides of the laminated structure are composed of the first-class metal plates 5 with the bent portions 14, and the inner plate 4 composed of the second-class metal plate is embedded in a bent overlapping region; or may be a five-layer structure as shown in FIG. 8b, in which the laminated structure comprises an upper plate 3 and a lower plate 5 made of the first-class metal, wherein the lower plate 5 has a bent portion 14, and two inner plates 4 made of the second-class metal are respectively inserted into a space formed by the upper plate 3, the lower plate 5 and the bent structure of the lower plate 5.

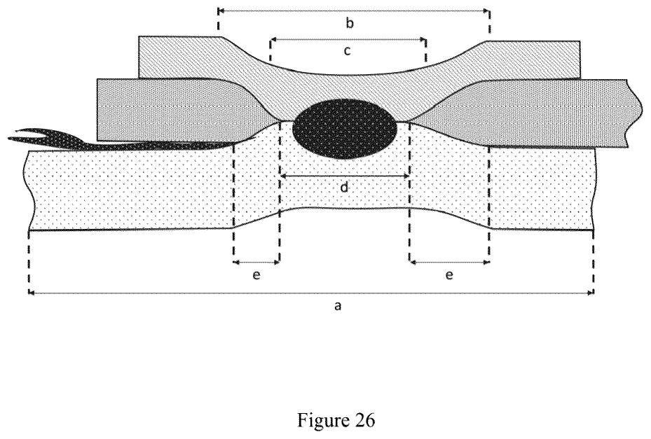

Referring to FIG. 26, various regions in the welded joint mentioned above are easily understood. A welded joint a has a structure that comprises a first-class metal plate and a second-class metal plate and forms a point connection. A welding region b is a region where the welding electrode welds the laminated structure and realizes connection under the influence of resistance heat. An indentation region c on the electrode end surface is a compression region formed when the end surface of the welding electrode is in contact with and applies a pressure to the dissimilar metal joint. A welding interface region d is a region consisting only of the first-class metal plates which are in contact with each other after the second-class metal has been separated. In addition, the welded joint further comprises a light metal thinning region e, the light metal thinning region e being a region that is progressively thinned from the original thickness of the second-class metal plate towards the welding interface region. The following is examples of the embodiments of the electric resistance welding method for the dissimilar metal joint.

### Example 1

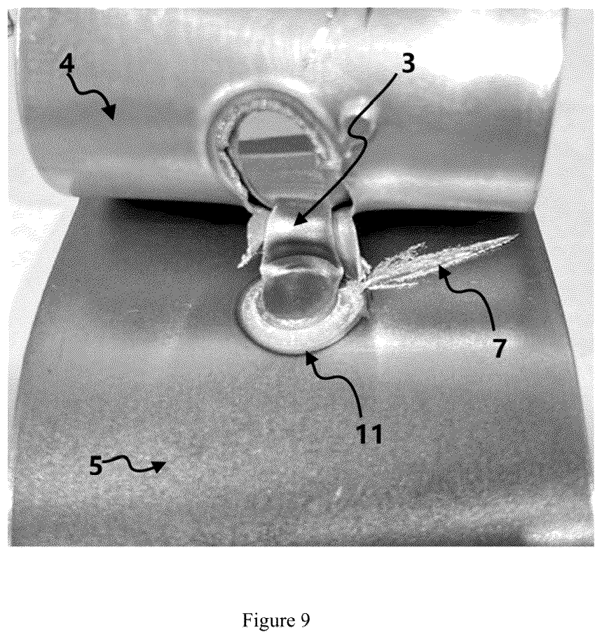

CR210 cold-rolled steel with a thickness of 0.8 mm and a tensile strength of less than 400 MPa is selected as the upper plate 3, an AA 6016 aluminum alloy with a thickness of 0.8 mm is selected as the inner plate 4, and CR420 cold-rolled steel with a thickness of 1.0 mm and a tensile strength of less than 600 MPa is selected as the lower plate 5; and both the first welding electrode 1 and the second welding electrode 2 are ordinary spherical electrodes each having a welding end surface of 6 mm. Specific welding process parameters are shown in Table 1, and a spalling fracture at the end of welding is shown in FIG. 9. On an interface between the inner plate 4 and the lower plate 5, there are solidified light metal splashes 7 which are radially distributed around a perimeter of a welding spot to the periphery. The results of a tensile shear load test on the welded joint are shown in Table 2. Due to the formation of strong steel-to-steel welding nuggets between the first-class metal plates 3, 5 and the second-class metal plate 4, the joint is shown to have an extremely high tensile shear strength of 3775 N by the tensile shear load test.

### Example 2

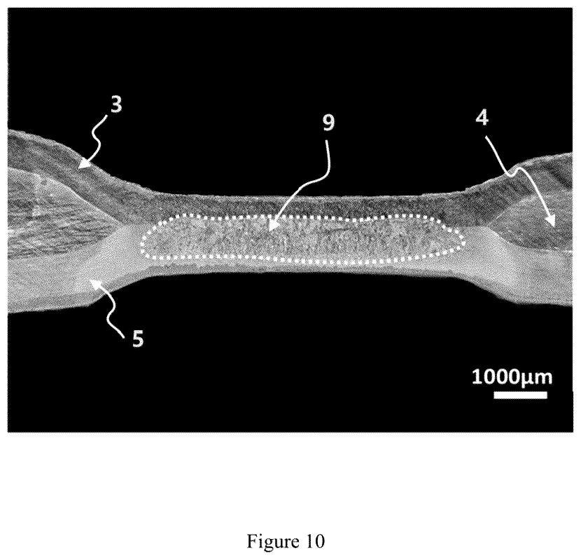

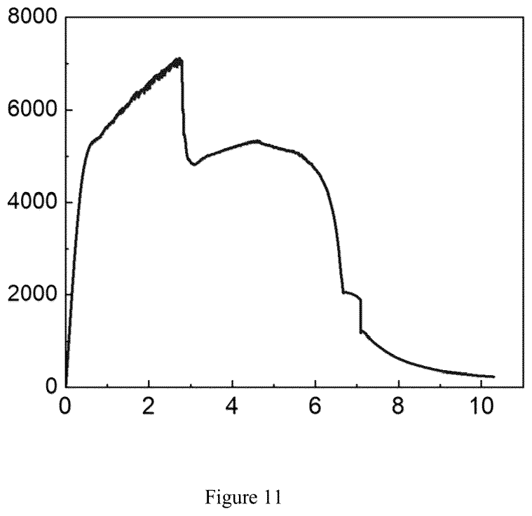

CR210 cold-rolled steel with a thickness of 1.0 mm and a tensile strength of less than 400 MPa is selected as the upper plate 3, and an AA 5754 aluminum alloy with a thickness of 1.2 mm is selected as the inner plate 4. Example 2 differs from Example 1 in terms of material selection in that: the upper plate 4 is a 5-series aluminum alloy; CR420 cold-rolled steel with a thickness of 1.0 mm and a tensile strength of less than 600 MPa is selected as the lower plate 5; and both the first welding electrode 1 and the second welding electrode 2 are ordinary spherical electrodes each having a welding end surface of 6 mm. Specific welding process parameters are shown in Table 1. A cross-sectional metallographical diagram of the joint is shown in FIG. 10. A tensile shear load test is performed on the joint at the end of welding, and a tensile shear load-displacement curve is shown in FIG. 11. The tensile shear load test shows that the joint has a very high tensile shear strength of 7292.4 N during the tensile shear process in an obvious plastic deformation stage. Peak load test results for tensile shear are shown in Table 2.

### Example 3

Q&P980 cold-rolled high-strength steel with a thickness of 1.0 mm and a tensile strength of generally not less than 1000 MPa is selected as the upper plate 3, an AA 5754 aluminum alloy with a thickness of 1.5 mm is selected as the inner plate 4, and Q&P1180 cold-rolled high-strength steel with a thickness of 1.2 mm and a tensile strength of generally not less than 1200 MPa is selected as the lower plate 5. Both the first welding electrode 1 and the second welding electrode 2 are ordinary spherical electrodes each having a welding end surface of 6 mm. Specific welding process parameters are shown in Table 1. A tensile shear load test is performed on the joint at the end of welding. The test shows that the joint also has a very high tensile shear strength of 7557.6 N. Peak load test results for tensile shear are shown in Table 2.

### Example 4

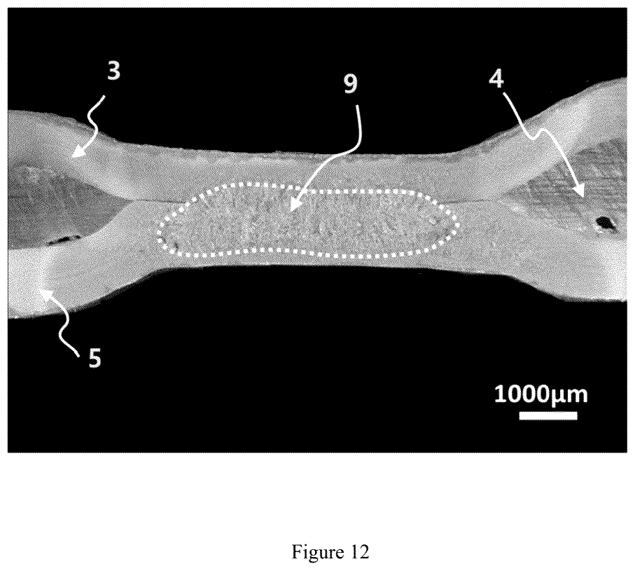

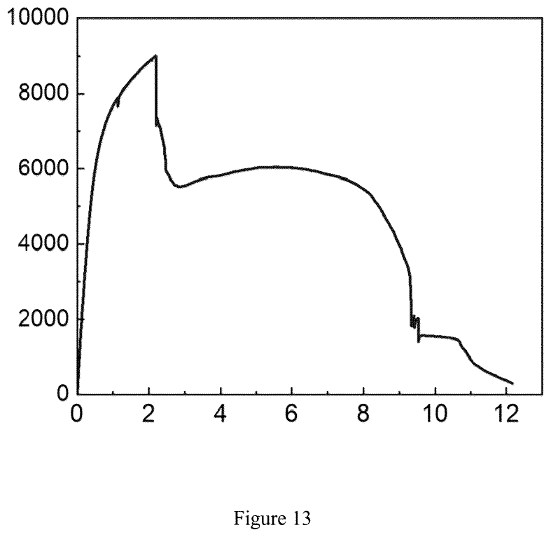

CR420 cold-rolled steel with a thickness of 1.0 mm and a tensile strength of less than 600 MPa is selected as the upper plate 3, an AA 6016 aluminum alloy with a thickness of 1.6 mm is selected as the inner plate 4, and Q&P1180 cold-rolled high-strength steel with a thickness of 1.2 mm and a tensile strength of generally not less than 1200 MPa is selected as the lower plate 5. Both the first welding electrode 1 and the second welding electrode 2 are ordinary spherical electrodes each having a welding end surface of 6 mm. Specific welding process parameters are shown in Table 1. A cross-sectional metallographical diagram of the joint is shown in FIG. 12. A tensile shear load test is performed on the joint at the end of welding, and a tensile shear load-displacement curve is shown in FIG. 13. The tensile shear load test shows a significant plastic deformation of the joint, with a very high strength of 8995.0 N. Peak load test results for tensile shear are shown in Table 2.

### Example 5

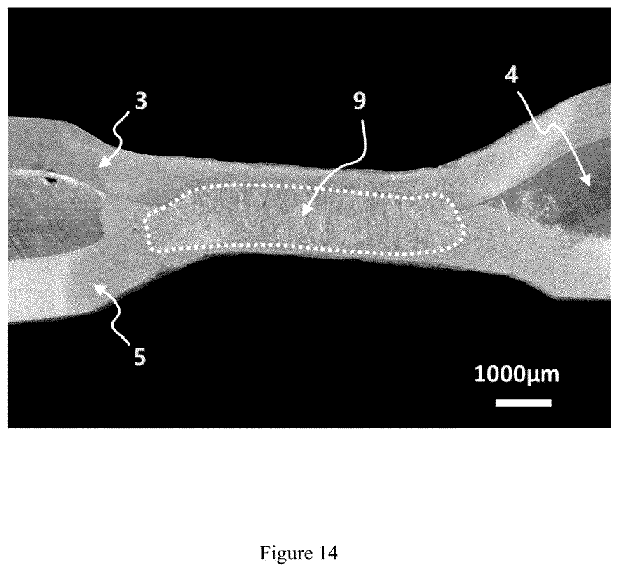

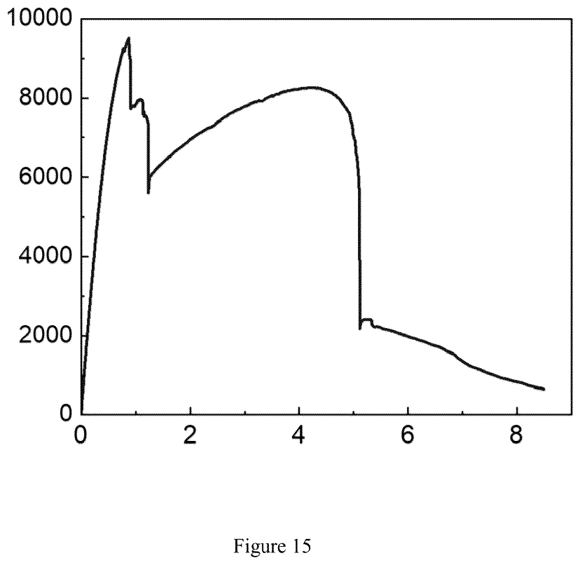

CR420 cold-rolled steel with a thickness of 1.0 mm and a tensile strength of less than 600 MPa is selected as the upper plate 3, an AA 6016 aluminum alloy with a thickness of 2.0 mm is selected as the inner plate 4, and Q&P1180 cold-rolled high-strength steel with a thickness of 1.2 mm and a tensile strength of generally not less than 1200 MPa is selected as the lower plate 5. Both the first welding electrode 1 and the second welding electrode 2 are ordinary spherical electrodes each having a welding end surface of 6 mm. Specific welding process parameters are shown in Table 1. A cross-sectional metallographical diagram of the joint is shown in FIG. 14. A tensile shear load test is performed on the joint at the end of welding, and a tensile shear load-displacement curve is shown in FIG. 15. The tensile shear load test shows that the joint has a very high tensile shear of 9508.4 N. Peak load test results for tensile shear are shown in Table 2.

### Example 6

Q&P980 cold-rolled high-strength steel with a thickness of 1.0 mm and a tensile strength of generally not less than 1000 MPa is selected as the upper plate 3, an AA 6061 aluminum alloy with a thickness of 2.0 mm is selected as the inner plate 4, and CR420 cold-rolled steel with a thickness of 1.4 mm and a tensile strength of less than 600 MPa is selected as the lower plate 5. In addition, the surface of the lower plate 5 has a zinc coating. Both the first welding electrode 1 and the second welding electrode 2 are ordinary spherical electrodes each having a welding end surface of 6 mm. Specific welding process parameters are shown in Table 1. A tensile shear load test is performed on the joint at the end of welding. The test results show that the joint also has a very high tensile shear strength of 10437.8 N. Peak load test results for tensile shear are shown in Table 2.

### Example 7

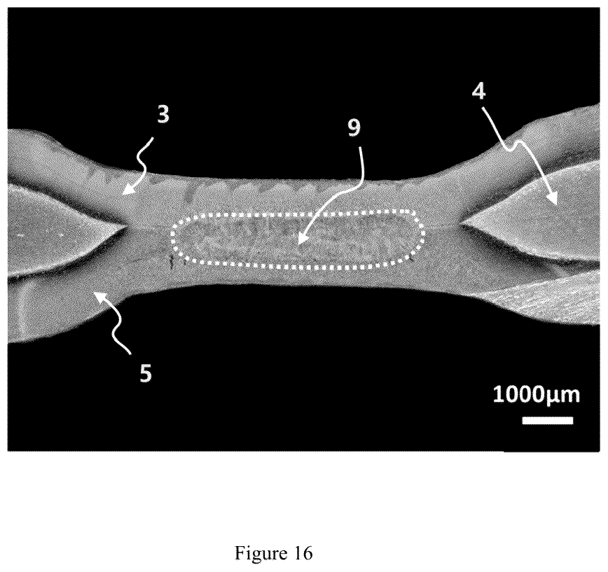

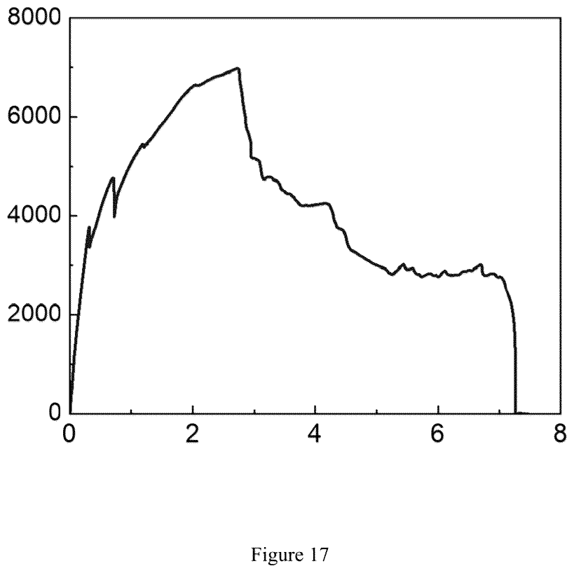

CR420 steel with a thickness of 1.0 mm and a tensile strength of less than 600 MPa is selected as the upper plate 3, an AZ31 magnesium alloy with a thickness of 2.0 mm is selected as the inner plate 4, and hot-formed ultra-high-strength steel with a thickness of 1.2 mm and a tensile strength of generally not less than 1300 MPa is selected as the lower plate 5. Both the first welding electrode 1 and the second welding electrode 2 are ordinary spherical electrodes each having a welding end surface of 6 mm. Specific welding process parameters are shown in Table 1. A cross-sectional metallographical diagram of the joint is shown in FIG. 16. A tensile shear load test is performed on the joint at the end of welding, and a tensile shear load-displacement curve is shown in FIG. 17. The tensile shear load test shows that the joint has a very high tensile shear of 6970.0 N. Peak load test results for tensile shear are shown in Table 2.

### Example 8

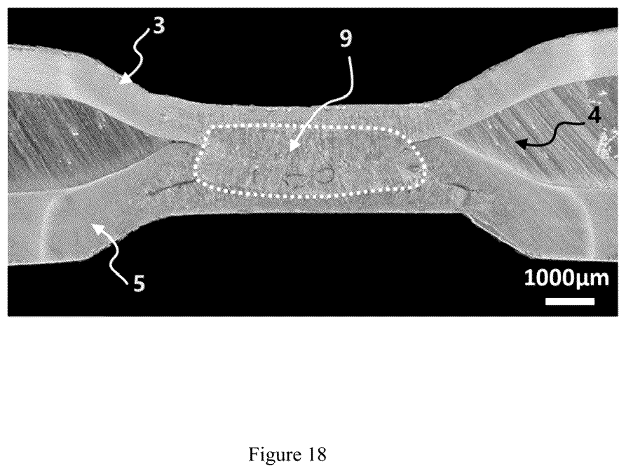

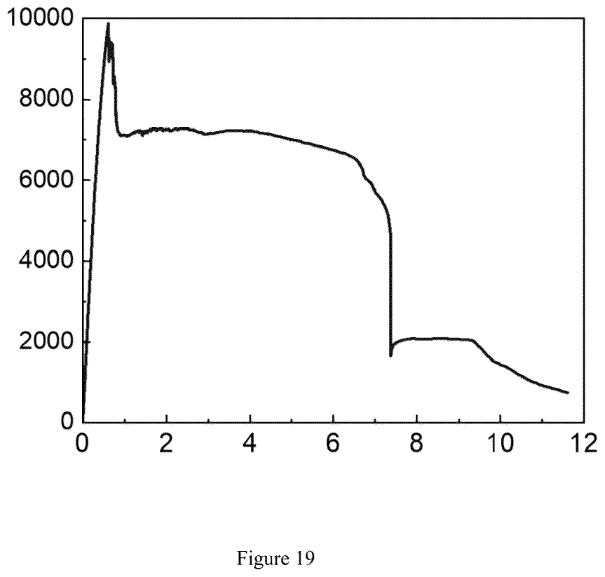

Q&P980 steel with a thickness of 1.0 mm and a tensile strength of generally not less than 1000 MPa is selected as the upper plate 3, a 6061 aluminum alloy profile with a thickness of 2.4 mm is selected as the inner plate 4, and hot-formed ultra-high-strength steel with a thickness of 1.4 mm is selected as the lower plate 5. Specific welding process parameters are shown in Table 1. A cross-sectional metallographical diagram of the joint is shown in FIG. 18. A tensile shear load test is performed on the joint at the end of welding, and a tensile shear load-displacement curve is shown in FIG. 19. The tensile shear load test shows that the joint has a very high tensile shear of 9883.4 N. Peak load test results for tensile shear are shown in Table 2.

### Example 9

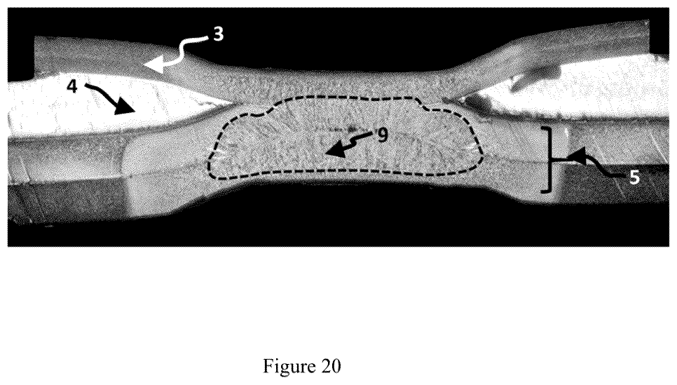

Q&P980 steel with a thickness of 1.0 mm is selected as the upper plate 3, an AA 6061 aluminum alloy with a thickness of 1.6 mm is selected as the inner plate 4, and hot-formed steel with a thickness of 1.2 mm and a tensile strength of 2000 MPa and Q&P1180 quenched steel with a thickness of 1.2 mm and a tensile strength of 1180 MPa are compounded as the lower plate 5, wherein the hot-formed steel is used as an upper layer portion of the lower plate 5, and the Q&P1180 steel is used as a lower layer portion of the lower plate 5. Welding is performed by using three 16 kA pulses as an expulsion current I1, with each pulse of the expulsion current lasting for 80 ms at an interval of 20 ms; the expulsion current is then cooled for 30 ms; and welding is performed by applying a 13 kA welding current I2 for 300 ms. A metallographical diagram of the resulting joint is shown in FIG. 20. In this example, I0 is 8.2 kA (welding time is 280 ms). It can be seen that a weld nugget structure 9 consists entirely of steel and contains no bright intermetallic compounds.

### Example 10

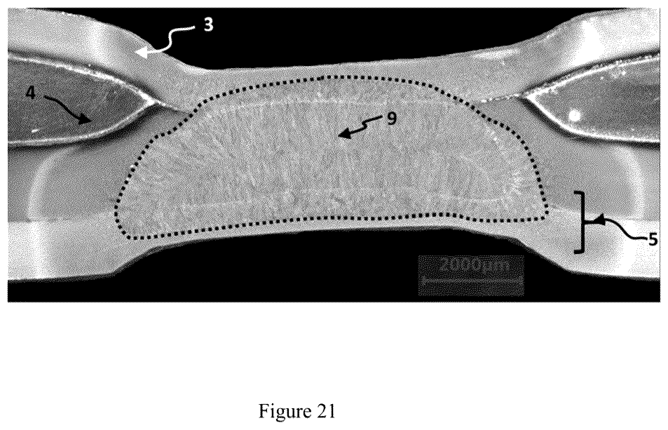

DP780 steel with a thickness of 1.0 mm is selected as the upper plate 3, an AZ31 magnesium alloy with a thickness of 2.0 mm is selected as the inner plate 4, and hot-formed steel with a thickness of 1.4 mm and a tensile strength of 2000 MPa and Q&P1180 quenched steel with a thickness of 1.2 mm and a tensile strength of 1180 MPa are compounded as the lower plate 5, wherein the hot-formed steel is used as an upper layer portion of the upper plate 5, and the Q&P1180 steel is used as a lower layer portion of the lower plate 5. Welding is performed by using three 19 kA pulses as an expulsion current I1, with each pulse of the expulsion current lasting for 80 ms at an interval of 20 ms; the expulsion current is then cooled for 30 ms; and welding is performed by applying a 13 kA welding current I2 for 400 ms. A metallographical diagram of the resulting joint is shown in FIG. 21. In this example, I0 is 8.7 kA (welding time is 280 ms). It can be seen that a weld nugget structure 9 consists entirely of steel and contains no bright intermetallic compounds.

### Example 11

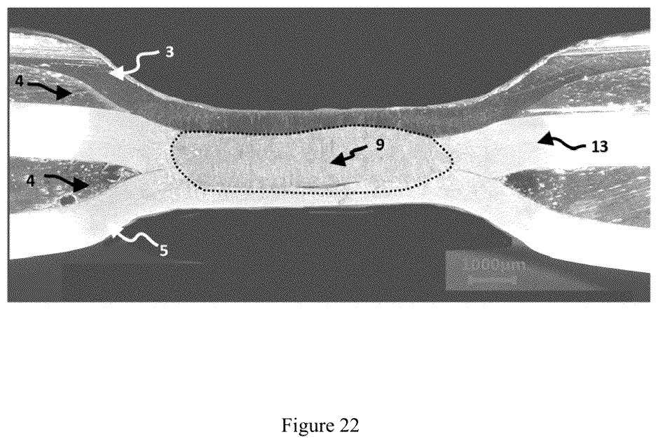

DP780 steel with a thickness of 1 mm is selected as the upper plate 3, and a 5754 aluminum alloy with a thickness of 0.8 mm and an AA 6061 aluminum alloy with a thickness of 1.6 mm are respectively selected as the inner plates 4 between which Q&P1180 quenched steel with a thickness of 1.2 mm and a tensile strength of 1200 MPa is inserted as the inner plate 13, DP780 steel with a thickness of 1 mm is selected as the lower plate 5 to constitute a five-layer composite structure, wherein the 5754 aluminum alloy is placed above the inner plate 13, and the AA 6061 aluminum alloy is placed below the inner plate 13. Preheating is performed for 100 ms by using a 6 kA preheating current; three 20 kA pulses are subsequently used as a expulsion current I1, with each pulse of the expulsion current lasting for 85 ms at an interval of 20 ms; the expulsion current is then cooled for 30 ms; and welding is performed by applying a 15 kA welding current I2 for 400 ms. A metallographical diagram of the resulting joint is shown in FIG. 22. In this example, I0 is 8.6 kA (welding time is 300 ms). It can be seen that a weld nugget structure 9 consists entirely of steel and contains no bright intermetallic compounds.

### Example 12

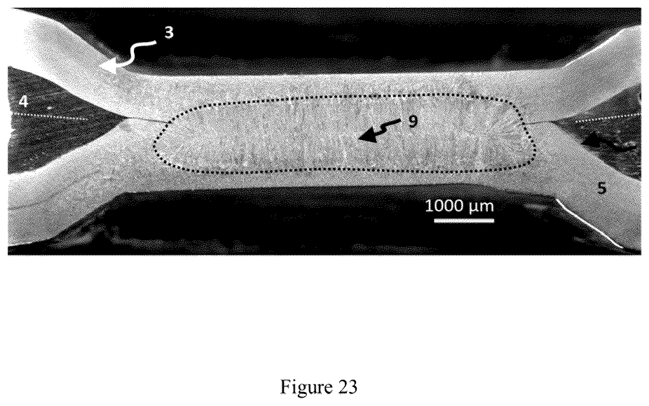

DP780 steel with a thickness of 1 mm is selected as the upper plate 3, a 5754 aluminum alloy with a thickness of 0.8 mm and an AA 6061 aluminum alloy with a thickness of 1.6 mm are compounded as the inner plate 4, and Q&P1180 quenched steel with a thickness of 1.2 mm and a tensile strength of 1200 MPa is used as the lower plate 5. Preheating is performed for 100 ms by using a 6 kA preheating current I4; three 21 kA pulses are subsequently used as a expulsion current I1, with each pulse of the expulsion current lasting for 80 ms at an interval of 20 ms; the expulsion current is then cooled for 30 ms; and welding is performed by applying a 15 kA welding current I2 for 380 ms. A metallographical diagram of the resulting joint is shown in FIG. 23. In this example, I0 is 8.5 kA (welding time is 280 ms). It can be seen that a weld nugget structure 9 consists entirely of steel and contains no bright intermetallic compounds.

### Comparative Example

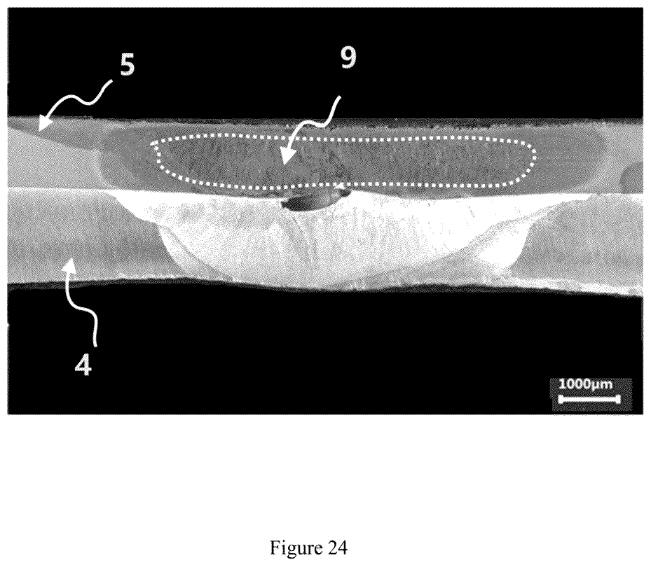

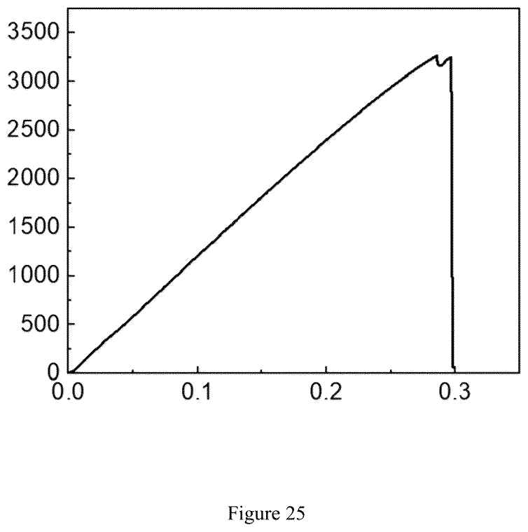

In order to compare with examples of the invention, this example is to weld an aluminum-steel dissimilar metal using conventional electric resistance spot welding methods. In the welding process, both the first welding electrode and a second welding electrode are spherical electrodes, each having a spherical radius of 100 mm and a welding surface diameter of 10 mm. Optimized better welding parameters are selected for welding. The used welding parameters are as follows: a welding pressure is 5600 N, a welding current is 17 kA, welding time is 100 ms, five pulses of current are adopted with an interval of 20 ms between pulses of current, and a holding time is 300 ms after welding. A metallographical diagram of a joint is as shown in FIG. 24. In the welding process, Q&P1180 steel with a thickness of 1.2 mm is selected as a first metal plate 5 and AA 6016 with a thickness of 1.6 mm is selected as a second metal plate 4. A tensile shear load test is performed on the joint after welding. The test results are shown in Table 2 and FIG. 25. The peak tensile shear load of the joint is only 3265.8 N, which is much lower than the peak load of the joint of the invention. In addition, a load-displacement curve shows that a joint displacement is extremely small, about 0.3 mm, and the brittleness is obvious, which is much smaller than that of the joint provided by the invention.

TABLE 1
Technological parameters of examples

| | | | | | | | | | Comparative |
|---|---|---|---|---|---|---|---|---|---|
| Items | Example 1 | Example 2 | Example 3 | Example 4 | Example 5 | Example 6 | Example 7 | Example 8 | example |
| Electrode | 4000 | 4000 | 4500 | 4500 | 5000 | 5000 | 5000 | 5000 | 5600 |
| pressure (N) | | | | | | | | | |
| Pre-pressing | 200 | 200 | 200 | 200 | 200 | 200 | 200 | 200 | 200 |
| time (ms) | | | | | | | | | |
| Preheating stage | — | — | — | — | 150 ms | 150 ms | 150 ms | 150 ms | — |
| | | | | | 6 kA | 6 kA | 6 kA | 6 kA | |
| expulsion stage | 15 kA | 15 kA | 18 kA | 18 kA | 22 kA | 22 kA | 20 kA | 20 kA | — |
| | 3 pulses | 3 pulses | 3 pulses | 3 pulses | 3 pulses | 3 pulses | 3 pulses | 3 pulses | |
| | 80 ms/pulse | 80 ms/pulse | 90 ms/pulse | 90 ms/pulse | 90 ms/pulse | 90 ms/pulse | 90 ms/pulse | 90 ms/pulse | |
| Interval time (ms) | 10 | 10 | 10 | 10 | 30 | 30 | 30 | 30 | — |
| Welding stage | 8 kA | 9 kA | 11 kA | 11 kA | 16 kA | 17 kA | 16 kA | 17 kA | 17 kA |
| | 200 ms | 220 ms | 250 ms | 250 ms | 300 ms | 350 ms | 350 ms | 350 ms | 5 pulses |
| Tempering stage | — | — | — | — | — | — | — | 180 ms | — |
| | | | | | | | | 5 kA | |
| holding time (ms) | 100 | 100 | 100 | 100 | 200 | 200 | 200 | 200 | 300 |
| Corresponding | 7.5 kA | 8 kA | 8.1 kA | 8.4 kA | 8.4 kA | 8.5 kA | 8.2 kA | 8.9 kA | |
| I0 and welding | 200 ms | 200 ms | 250 ms | 250 ms | 250 ms | 280 ms | 280 ms | 280 ms | |
| time | | | | | | | | | |

TABLE 2
Tensile shear loads of welded joints of the examples

| | Lower plate | Tensile | Inner plate | Upper plate | Tensile |
|---|---|---|---|---|---|
| | material/ | strength | material/ | material/ | shear load |
| Items | thickness (mm) | (MPa) | thickness (mm) | thickness (mm) | (N) |
| Example 1 | CR420/1.0 | ≤600 MPa | AA 6016/0.8 | CR210/0.8 | 3775.0 |
| Example 2 | CR420/1.0 | ≤600 MPa | AA 5754/1.2 | CR210/1.0 | 7292.4 |
| Example 3 | Q&P1180/1.2 | ≥1200 | AA 5754/1.5 | Q&P980/1.0 | 7557.6 |
| Example 4 | Q&P1180/1.2 | ≥1200 | AA 6016/1.6 | CR420/1.0 | 8995.0 |
| Example 5 | Q&P1180/1.2 | ≥1200 | AA 6016/2.0 | CR420/1.0 | 9508.4 |
| Example 6 | CR420 (surface | ≤600 | AA 6061/2.0 | Q&P980/1.0 | 10437.8 |
| | plated with a | | | | |
| | Zn layer)/1.4 | | | | |
| Example 7 | Hot-formed | ≥1300 | AZ31 | CR420/1.0 | 6970.0 |
| | steel/1.2 | | (magnesium | | |
| | | | alloy)/2.0 | | |
| Example 8 | Hot-forming | ≥1300 | AA 6061 | Q&P980/1.0 | 9883.4 |
| | steel/1.4 | | (profile)/2.4 | | |
| Comparative | Q&P1180/1.2 | ≥1200 | AA 6016/1.6 | — | 3264.8 |
| example | | | | | |

It should be understood that the above examples are intended to enable those skilled in the art to better understand the technical conception of the invention in conjunction with the accompanying drawings, and do not constitute a specific limitation of the embodiments and the protection scope of the invention. Within the scope of the claims of the invention, the modifications or replacements of relevant parts, materials and process steps, as well as the combinations of different embodiments without conflicting adjustments all fall within the protection scope of the invention.

We claim:

1. An electric resistance welding method for a dissimilar metal joint having a laminated structure of dissimilar metals, wherein the laminated structure comprises a plurality of first-class metal plates on outer sides and a second-class metal plate located between the first-class metal plates, comprising the steps of
(1) discharging the second-class metal plate from a welding region, wherein the step of discharging the second-class metal plate further comprises the steps of
applying an expulsion current and an electrode pressure to a laminated structure to heat the laminated structure in the welding region,
melting and expelling the second-class metal from the welding region in a form of expulsion under pressure, wherein the second-class metal plate is completely removed from at least part of the welding region, and the first-class metal plates are close to each other under an action of a resistance heat and an electrode pressure, and
forming a welding interface comprising the first-class metal plates in contact with each other, wherein a thickness of the second-class metal layer remaining in the welding interface is less than or equal to 0.15 mm; and
(2) welding to form a dissimilar metal joint, wherein the welding interface comprising the first-class metal plates in contact with each other is formed in at least part of the welding region, and the welding interface produces a metallurgical connection, and
wherein the first-class metal plates are made of pure iron or iron-based alloy, and the second-class metal plate is made of an elementary substance or an alloy with a density of less than 5.0 g/cm³ or a melting point of lower than 800° C.

2. The electric resistance welding method for the dissimilar metal joint according to claim 1, wherein the expulsion current comprises one or more current pulses, and a duration of a single pulse does not exceed 200 ms.

3. The electric resistance welding method for the dissimilar metal joint according to claim 1, wherein the expulsion current has an intensity I1=K1*I0, I0 is a current intensity when the first-class metal plates in the dissimilar metal joint are separately subjected to single pulse electric resistance welding to form a nugget having a section diameter of greater than or equal to 4\sqrt{t}, t is a thickness of the thinner plate in the first-class metal plates, and K1 has a value in a range of 0.8 to 3.5.

4. The electric resistance welding method for the dissimilar metal joint according to claim 1, wherein in step (1), the thickness of the second-class metal layer remaining in the welding interface is less than or equal to 0.05 mm, and an equivalent diameter of the welding interface is greater than or equal to 0.5 times a diameter of an electrode end surface of a welding electrode.

5. The electric resistance welding method for the dissimilar metal joint according to claim 1, wherein in step (2), a welding current and an electrode pressure are applied to the laminated structure, and the welding current has an intensity of less than or equal to the intensity of the expulsion current.

6. The electric resistance welding method for the dissimilar metal joint according to claim 1, wherein I2=K2*I0, in which 12 is an intensity of the welding current, I0 is a current intensity when the first-class metal plates in the dissimilar metal joint are separately subjected to single pulse electric resistance welding to form a nugget having a section diameter of greater than or equal to 4\sqrt{t}, t is a thickness of the thinner plate in the first-class metal plates, and K2 has a value range of 0.5-2.5.

7. The electric resistance welding method for the dissimilar metal joint according to claim 1, wherein an interval between the expulsion current and the welding current is 0 ms-200 ms.

8. The electric resistance welding method for the dissimilar metal joint according to claim 1, further comprising
providing a tempering current for the welding region by an electrode after the step (2) welding.

9. The electric resistance welding method for the dissimilar metal joint according to claim 8, wherein the tempering current has an intensity 13=K3*I0, wherein I0 is a current intensity when the first-class metal plates in the dissimilar metal joint are separately subjected to single pulse electric resistance welding to form a nugget having a section diameter of greater than or equal to 4\sqrt{t}, t is a thickness of the thinner plate in the first-class metal plates, and K3 has a value range of 0.4 to 1.8.

10. The electric resistance welding method for the dissimilar metal joint according to claim 1, further comprising
preheating a region to be welded by a preheating current provided by an electrode prior to the step of applying the expulsion current and an electrode pressure to the laminated structure.

11. The electric resistance welding method for the dissimilar metal joint according to claim 10, wherein the preheating current has an intensity I4=K4*I0, wherein I0 is a current intensity when the first-class metal plates in the dissimilar metal joint are separately subjected to single pulse electric resistance welding to form a nugget having a section diameter of greater than or equal to 4\sqrt{t}, t is a thickness of the thinner plate in the first-class metal plates, and K4 has a value range of 0.2-1.3.

12. The electric resistance welding method for the dissimilar metal joint according to claim 1, further comprising
preheating the region to be welded by a preheating current provided by an electrode prior to the step of applying the expulsion current and an electrode pressure to the laminated structure, and
after the step (2) welding, providing a tempering current for the welding region by the electrode,
wherein the expulsion current has an intensity I1=K1*I0, the welding current has an intensity I2=K2*I0, the preheating current has an intensity I4=K4*I0, and the tempering current has an intensity I3=K3*I0, wherein I0 is a current intensity when the first-class metal plates in the dissimilar metal joint are separately subjected to single pulse electric resistance welding to form a nugget having a section diameter of greater than or equal to 4\sqrt{t}, t is a thickness of the thinner plate in the first-class metal plates, K1 has a value range of 0.8-3.5, K2 has a value range of 0.5-2.5, K4 has a value range of 0.2-1.3, and K3 has a value range of 0.4-1.8, K₁≥K₂≥K₃≥K₄.

13. The electric resistance welding method for the dissimilar metal joint according to claim 12, wherein the welding current, the preheating current, and the tempering current each have at least one current pulse, and an action time does not exceed 800 ms, preferably 200-700 ms.

14. The electric resistance welding method for the dissimilar metal joint according to claim 12, wherein an interval of 0 to 200 ms exists between the welding current or the preheating current and the expulsion current, and between the tempering current and the welding current.

15. The electric resistance welding method for the dissimilar metal joint according to claim 1, wherein a coating exists on the surface of at least one of the first-class metal plates, and the coating is a zinc-based coating or an aluminum-based coating.

16. The electric resistance welding method for the dissimilar metal joint according to claim 1, wherein a structural form of the laminated structure is a three-layer group or a five-layer group;
two outer layer groups of the three-layer group are single layers or adjacent superimposed layers of the first-class metal plates, and an inner layer group is a single layer or adjacent superimposed layers of the second-class metal plates; and
two outer layer groups and an intermediate layer group of the five-layer group are single layers or adjacent superimposed layers of the first-class metal plates, and the other two layer groups are single layers or adjacent superimposed layers of the second-class metal plates and are respectively located between the outer layer groups and the intermediate layer group.

17. The electric resistance welding method for the dissimilar metal joint according to claim 1, wherein at least two layers of the first-class metal plates in the laminated structure are formed by bending the same metal plate, and the bent position is located outside the welding region.

18. The electric resistance welding method for the dissimilar metal joint according to claim 1, wherein the second-class metal plate is made of aluminum, an aluminum alloy, magnesium, a magnesium alloy, or a combination of any two materials selected from the group consisting of aluminum, an aluminum alloy, magnesium, and a magnesium alloy.

19. The electric resistance welding method for the dissimilar metal joint according to claim 1, wherein a thickness of a single layer or adjacent superimposed layers of second-class metal plates between the first-class metal plates which are spaced adjacently is less than or equal to 4.5 mm, and a total thickness of a single layer or the adjacent superimposed layers of first-class metal plates is less than or equal to 5.5 mm.

20. The electric resistance welding method for the dissimilar metal joint according to claim 1, wherein one of the plates on both outer sides of the laminated structure has a smaller value of a product of a thickness (in mm) and a tensile strength (in MPa) of the plate compared to the other.

21. A dissimilar metal joint, comprising
a laminated structure comprising first-class metal plates and a second-class metal plate;
wherein the first-class metal plates are made of pure iron or iron-based alloy;
the second-class metal plate is made of an elementary substance or an alloy with a density of less than 5.0 g/cm³ or a melting point of lower than 800° C.;
plates on the outer sides of the laminated structure are the first-class metal plates, and the second-class metal plate is located between the first-class metal plates; and
from the perspective of a cross section of the dissimilar metal joint, an indentation region on an electrode end surface and its surrounding materials present the characteristics of being thin in the middle and thick in both sides;
a thickness of the dissimilar metal joint in the indentation region on the electrode end surface is less than or equal to a sum of the thicknesses of the first-class metal plates;
a middle indentation region among the indentation regions on the electrode end surface consists only of the first-class metal plates, and interatomic bonding occurs between the first-class metal plates at an interface to form a permanent connection; and the thickness of the laminated structure gradually increases from an edge of the indentation region to the outside, and the second-class metal plate gradually increases from a smaller thickness to an original thickness of the second-class metal plate between the first-class metal plates.

22. The dissimilar metal joint according to claim 21, wherein a “jet-like” solidification structure formed by melting and expulsion of the second-class metal plate exists the first-class metal plate and the second-class metal plate outside the indentation region.

23. The dissimilar metal joint according to claim 21, wherein an intermetallic compound (IMC layer) is produced at a contact interface between the second-class metal plate and the first-class metal plate in the indentation edge region on the electrode end surface.

24. The dissimilar metal joint according to claim 21, wherein among the first-class metal plates in the laminated structure, at least two layers are formed by bending the same metal plate, and the bent position is located outside the welding region.

25. A dissimilar metal joint obtained according to the method according to claim 1.
